(19) United States
(12) Patent Application Publication
(10) Pub. No.: US 2025/0097036 A1
(43) Pub. Date: Mar. 20, 2025

(54) AUTHENTICATING A USER OF A WIRELESS TELECOMMUNICATION NETWORK BASED ON A NON-FUNGIBLE TOKEN INDICATING AN ATTRIBUTE ASSOCIATED WITH THE MOBILE DEVICE OPERATING ON THE WIRELESS TELECOMMUNICATION NETWORK

(71) Applicant: T-Mobile USA, Inc., Bellevue, WA (US)

(72) Inventors: Joohyung Kim, Seattle, WA (US); Jie Hui, Mercer Island, WA (US); Jim Joojin Song, Atlanta, GA (US)

(21) Appl. No.: 18/467,673

(22) Filed: Sep. 14, 2023

(51) Int. Cl. H04L 9/32; H04L 9/08; H04W 12/06; H04W 12/30; H04W 12/71

(52) U.S. Cl. CPC H04L 9/3213; H04L 9/0894; H04W 12/06; H04W 12/30; H04W 12/71

(57) ABSTRACT

The system obtains an indication of an attribute of a UE operating on a network. The system obtains an NFT based on the attribute of the UE and an ID of the NFT. The system creates a digital wallet based on a public cryptographic key associated with the UE, where the digital wallet can store the NFT and a private cryptographic key associated with the UE. The system stores the NFT in the digital wallet. Storing the NFT indicates that the attribute included in the NFT belongs to the user of the UE. The system receives, from a third party independent of the network, a request to authenticate the user based on the attribute, and provides, to the third party, the ID of the NFT and an address of the digital wallet, where the third party authenticates the user upon verifying that the ID of the NFT is stored in the digital wallet.

### BACKGROUND

A user of a mobile device operating on a wireless telecommunication network can receive certain benefits redeemable through a third party. However, the third party may not have access to the databases of the wireless telecommunication network indicating which benefits are available to the user. Consequently, the third party can have difficulty authenticating that the user is eligible for the benefit.

### BRIEF DESCRIPTION OF THE DRAWINGS

Detailed descriptions of implementations of the present invention will be described and explained through the use of the accompanying drawings.

FIG. 1 is a block diagram that illustrates a wireless telecommunication network in which aspects of the disclosed technology are incorporated.

FIG. 2 is a block diagram illustrating a portion of an example blockchain system.

FIG. 3A illustrates a process that uses a hash algorithm to generate a non-fungible token (NFT) or perform a cryptographic transaction on a blockchain.

FIG. 3B is a block diagram illustrating an example digital wallet device.

FIG. 4 is a flowchart of a method to authenticate a user of a wireless telecommunication network based on an NFT indicating an attribute associated with a user equipment (UE) operating on the wireless telecommunication network.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Disclosed here is a system and method to authenticate a user of a wireless telecommunication network based on a non-fungible token (NFT) indicating an attribute associated with a mobile device operating on the wireless telecommunication network. The system obtains an indication of the attribute associated with the mobile device operating on the wireless telecommunication network, where the attribute includes at least two of the following four attributes: a phone number associated with the mobile device, an International Mobile Equipment Identity (IMEI) associated with the mobile device, International mobile subscriber identity (IMSI), or a unique identifier (ID) associated with a user of the mobile device. The attribute can also include coupons, promotions, plans, or bills associated with the wireless telecommunication network.

The system creates the NFT based on the attribute associated with the mobile device and an ID associated with the NFT. The ID associated with the NFT uniquely identifies the NFT on a blockchain, and no other NFT can have the same ID. The ID associated with the NFT can be an alphanumeric string such as a unit 256 variable called tokenId. The NFT can be stored on a blockchain, or the blockchain can store a token that points to the NFT metadata, which is usually stored in a decentralized file system, e.g. InterPlanetary File System (IPFS). The NFT can be publicly readable or can be encrypted using the user's public cryptographic key.

The system creates a digital wallet based on a public cryptographic key associated with the user of the mobile device. The public cryptographic key is paired with and corresponds to the private cryptographic key. The address of the digital wallet corresponds to the public cryptographic key, and can be the same as the public cryptographic key. The digital wallet is configured to store a private cryptographic key associated with a user of the mobile device operating on the wireless telecommunication network. The blockchain can indicate that the NFT belongs to the digital wallet corresponding to the public cryptographic key. Storing of the private cryptographic key in the digital wallet indicates that the owner of the wallet owns the NFT. The private cryptographic key can allow the digital wallet owner to authorize transactions. If the digital wallet owns the private cryptographic key, the digital wallet effectively owns anything at that blockchain address.

The system stores the private cryptographic key in the digital wallet, where storing the private cryptographic key indicates that the attribute included in the NFT belongs to the user of the mobile device. Thus, when the system receives a request from a third party independent of the wireless telecommunication network to authenticate the user based on the attribute, the system can provide, to the third party, the ID associated with the NFT and a public cryptographic key associated with the user, where the third party authenticates the user upon verifying that the private cryptographic key associated with the NFT is stored in the digital wallet. For example, the user of the mobile device can redeem a coupon or a code and receive a discount or a free offering from the third party independent of the wireless telecommunication network.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

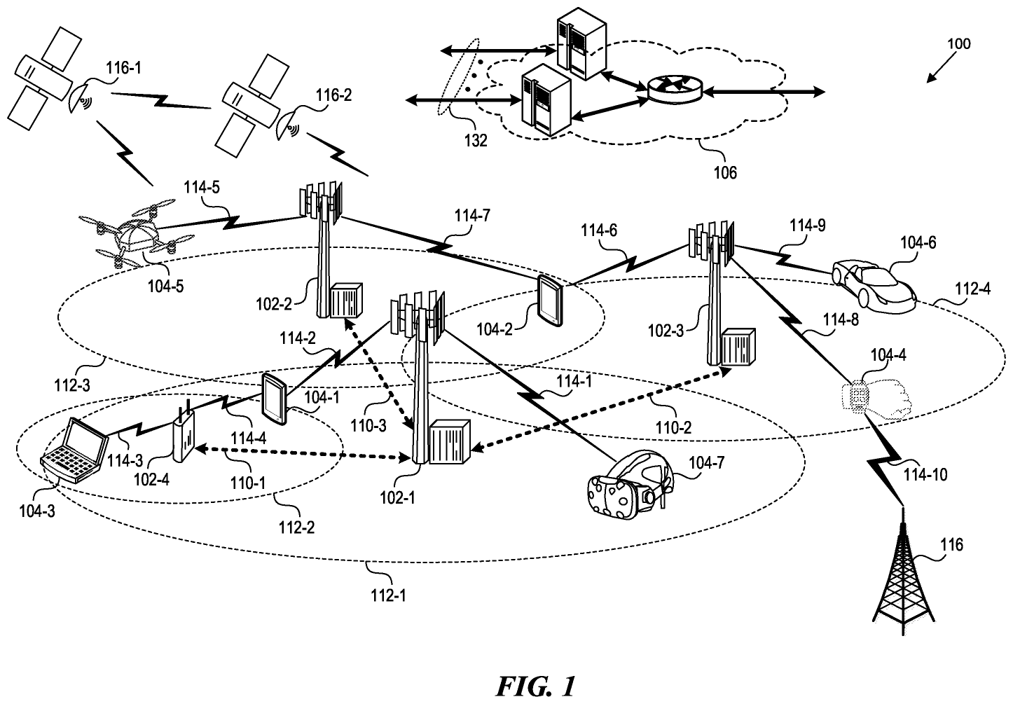

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104-1 through 104-7 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The geographic coverage area 112 for a base station 102 can be divided into sectors making up only a portion of the coverage area (not shown). The network 100 can include base stations of different types (e.g., macro and/or small cell base stations). In some implementations, there can be overlapping geographic coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the system 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances, etc.

A wireless device (e.g., wireless devices 104-1, 104-2, 104-3, 104-4, 104-5, 104-6, and 104-7) can be referred to as a user equipment (UE), a customer premise equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102, and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) (e.g., using unpaired spectrum resources) operation. In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites such as satellites 116-1 and 116-2 to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service requirements and multi-terabits-per-second data transmission in the 6G and beyond era, such as terabit-per-second backhaul systems, ultrahigh-definition content streaming among mobile devices, AR/VR, and wireless high-bandwidth secure communications. In another example of 6G, the network 100 can implement a converged Radio Access Network (RAN) and core architecture to achieve Control and User Plane Separation (CUPS) and achieve extremely low user plane latency. In yet another example of 6G, the network 100 can implement a converged Wi-Fi and core architecture to increase and improve indoor coverage.

### Authenticating a User of a Wireless Telecommunication Network Based on an NFT Indicating an Attribute Associated with the Mobile Device Operating on the Wireless Telecommunication Network

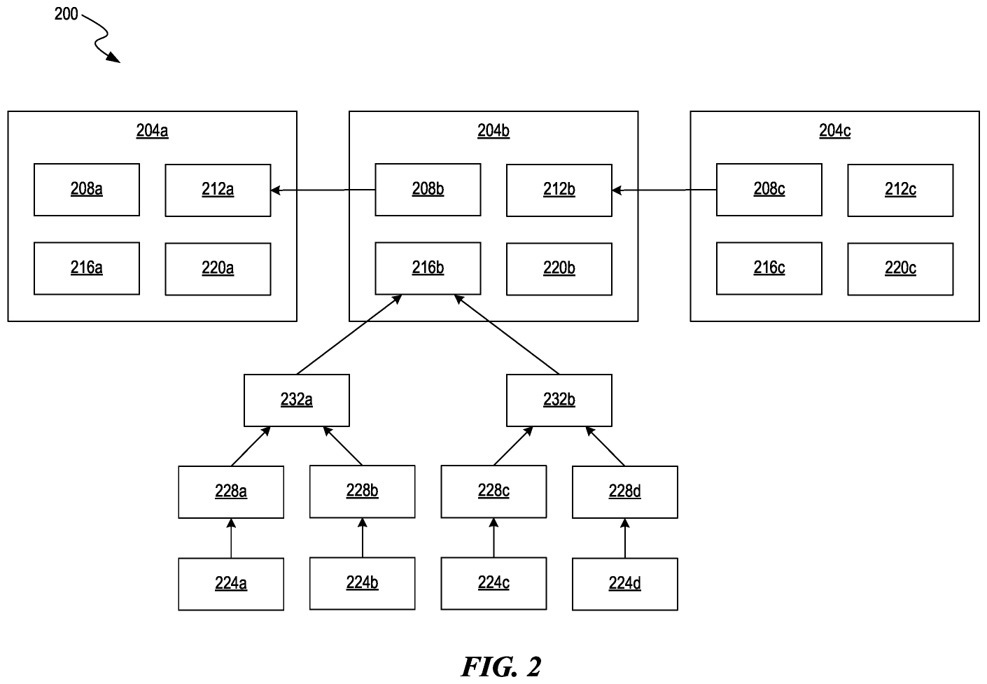

FIG. 2 is a block diagram illustrating a portion of an example blockchain system 200. The blockchain system 200 includes blockchain 204. In embodiments, the blockchain 204 is a distributed ledger of transactions (e.g., a continuously growing list of records, such as records of transactions for digital assets such as cryptocurrency, bitcoin, or electronic cash) that is maintained by the blockchain system 200. For example, the blockchain 204 is stored redundantly at multiple nodes (e.g., computers) of a blockchain network. Each node in the blockchain network can store a complete replica of the entire blockchain 204. In some embodiments, the blockchain system 200 implements storage of an identical blockchain at each node, even when nodes receive transactions in different orderings. The blockchain 204 shown by FIG. 2 includes blocks 204a, 204b, 204c. Likewise, embodiments of the blockchain system 200 can include different and/or additional components or be connected in different ways.

The terms “blockchain” and “chain” are used interchangeably herein. In embodiments, the blockchain 204 is a distributed database that is shared among the nodes of a computer network. As a database, the blockchain 204 stores information electronically in a digital format. The blockchain 204 can maintain a secure and decentralized record of transactions (e.g., transactions 224a, 224b). For example, the ERC-721 or ERC-1155 standards are used for maintaining a secure and decentralized record of transactions. The blockchain 204 provides fidelity and security for the data record. In embodiments, the blockchain 204 collects information together in groups, known as “blocks” (e.g., blocks 204a, 204b), that hold sets of information.

The blockchain 204 structures its data into chunks (blocks) (e.g., blocks 204a, 204b) that are strung together. Blocks (e.g., block 204c) have certain storage capacities and, when filled, are closed and linked to a previously filled block (e.g., block 204b), forming a chain of data known as the “blockchain.” New information that follows a freshly added block (e.g., block 204b) is compiled into a newly formed block (e.g., block 204c) that will then also be added to the blockchain 204 once filled. The data structure inherently makes an irreversible timeline of data when implemented in a decentralized nature. When a block is filled, it becomes a part of this timeline of blocks. Each block (e.g., block 204a) in the blockchain 204 is given an exact timestamp (e.g., timestamp 212a) when it is added to the blockchain 204. In the example of FIG. 2, blockchain 204 includes multiple blocks 204a-c. Each of the blocks 204a-c can represent one or multiple transactions and can include a cryptographic hash of the previous block (e.g., previous hashes 208a-c), a timestamp (e.g., timestamps 212a-c), a transactions root hash (e.g., 216a-c), and a nonce (e.g., 220a-c). A transactions root hash (e.g., transactions root hash 216b) indicates the proof that the block 204b contains all the transactions in the proper order. The transactions root hash 216b proves the integrity of transactions in the block 204b without presenting all transactions.

In embodiments, the timestamp 212a-c of each of corresponding blocks 204a-c includes data indicating a time associated with the block. In some examples, the timestamp includes a sequence of characters that uniquely identifies a given point in time. In one example, the timestamp of a block includes the previous timestamp in its hash and enables the sequence of block generation to be verified.

In embodiments, nonces 220a-c of each of corresponding blocks 204a-c include any generated random or semi-random number. The nonce can be used by miners (e.g., devices that validate blocks) during proof of work (PoW), which refers to a form of adding new blocks of transactions to blockchain 204. The work refers to generating a hash that matches the target hash for the current block. For example, a nonce is an arbitrary number that miners can change in order to modify a header hash and produce a hash that is less than or equal to the target hash value set by the network.

As described above, each of blocks 204a, 204b, 204c of exemplary blockchain 204 can include respective block hash 216a, 216b, 216c. Each of block hashes 216a-c can represent a hash of a root node of a Merkle tree for the contents of the block (e.g., the transactions of the corresponding block). For example, the Merkle tree contains leaf nodes corresponding to hashes of components of the transaction, such as a reference that identifies an output of a prior transaction that is input to the transaction, an attachment, and a command. Each non-leaf node can contain a hash of the hashes of its child nodes. The Merkle tree can also be considered to have each component as the leaf node with its parent node corresponding to the hash of the component.

In the example of FIG. 2, block 204b records transactions 224a-d. Each of the leaf nodes 228a-d contains a hash corresponding to transactions 224a-d, respectively. As described above, a hash (e.g., the hash in leaf node 228a) can be a hash of components of a transaction (e.g., transaction 224a), for example, a reference that identifies an output of a prior transaction that is input to the transaction 224a, an attachment, and a command. Each of the non-leaf nodes 232a, 232b can contain a hash of the hashes of its child nodes (e.g., leaf nodes 228a-b). In this example, node 232a can contain a hash of the hashes contained in 228a, 228b and node 232b can contain a hash of the hashes contained in 228c, 228d. The root node 216b can contain a hash of the hashes of child nodes 232a-b.

A Merkle tree representation of a transaction (e.g., 224a) allows an entity needing access to the transaction 224a to be provided with only a portion that includes the components that the entity needs. For example, if an entity needs only the transaction summary, the entity can be provided with the nodes (and each node's sibling nodes) along the path from the root node to the node of the hash of the transaction summary. The entity can confirm that the transaction summary is that used in the transaction 224a by generating a hash of the transaction summary and calculating the hashes of the nodes along the path to the root node. If the calculated hash of the root node matches the hash 228a of the transaction 224a, the transaction summary is confirmed as the one used in the transaction. Because only the portion of the Merkle tree relating to components that an entity needs is provided, the entity will not have access to other components. Thus, the confidentiality of the other components is not compromised.

In some examples, the blockchain system 200 is a bitcoin system developed to allow digital assets such as electronic cash to be transferred directly from one party to another without going through a central authority, such as a financial institution (e.g., as described in the white paper entitled “Bitcoin: A Peer-to-Peer Electronic Cash System” by Satoshi Nakamoto, hereby incorporated by reference in its entirety). A bitcoin (an electronic coin) can be represented by a chain of transactions that transfers ownership from one party to another party.

To transfer ownership of a digital asset, such as a bitcoin, using the blockchain system 200, a new transaction, such as one of transactions 224a-d, is generated and added to a stack of transactions in a block, e.g., block 204b. To record a transaction in a blockchain, each party and asset involved with the transaction needs an account that is identified by a digital token. For example, when a first user wants to transfer an asset that the first user owns to a second user, the first and second users both create accounts, and the first user also creates an account that is uniquely identified by the asset's identification number. The account for the asset identifies the first user as being the current owner of the asset. The first user (i.e., the current owner) creates a transaction (e.g., 224a) against the account for the asset that indicates that the transaction 224a is a transfer of ownership and outputs a token identifying the second user as the next owner and a token identifying the asset. The transaction 224a is signed by a private cryptographic key (“private key”) of the first user (i.e., the current owner), and the transaction 224a is evidence that the second user is now the new current owner and that ownership has been transferred from the first to the second user.

The new transaction 224a, which includes the public key of the new owner (e.g., a second user to whom a digital asset is assigned ownership in the transaction), is digitally signed by the first user with the first user's private key to transfer ownership to the second user (e.g., new owner), as represented by the second user public key. The signing by the owner of the bitcoin is an authorization by the owner to transfer ownership of the bitcoin to the new owner via the new transaction 224a. Once the block is full, the block is “capped” with a block header, that is, a hash digest of all the transaction identifiers within the block. The block header is recorded as the first transaction in the next block in the chain, creating a mathematical hierarchy called the “blockchain.” To verify the current owner, the blockchain 204 of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

Additionally, in some embodiments, the blockchain system 200 uses one or more smart contracts to enable more complex transactions. A smart contract includes computer code implementing transactions of a contract. The computer code can be executed on a secure platform (e.g., an Ethereum™ platform, which provides a virtual machine) that supports recording transactions (e.g., 224a-d) in blockchains. For example, a smart contract can be a self-executing contract with the terms of the agreement between buyer and seller being directly written into lines of code. The code and the agreements contained therein exist across a distributed, decentralized blockchain network.

In addition, the smart contract can itself be recorded as a transaction 224a in the blockchain 204 using a token that is a hash 228a of the computer code so that the computer code that is executed can be authenticated. When deployed, a constructor of the smart contract executes, initializing the smart contract and its state. The state of a smart contract is stored persistently in the blockchain 204. When a transaction 224a is recorded against a smart contract, a message is sent to the smart contract, and the computer code of the smart contract executes to implement the transaction (e.g., debit a certain amount from the balance of an account). The computer code ensures that all the terms of the contract are complied with before the transaction 224a is recorded in the blockchain 204.

For example, a smart contract can support the sale of an asset. The inputs to a smart contract to sell an asset can be tokens identifying the seller, the buyer, the asset, and the sale price in U.S. dollars or cryptocurrency. The computer code is used to ensure that the seller is the current owner of the asset and that the buyer has sufficient funds in their account. The computer code records a transaction (e.g., 224a) that transfers the ownership of the asset to the buyer and a transaction (e.g., 224b) that transfers the sale price from the buyer's account to the seller's account. If the seller's account is in U.S. dollars and the buyer's account is in Canadian dollars, the computer code can retrieve a currency exchange rate, determine how many Canadian dollars the seller's account should be debited, and record the exchange rate. If either transaction 224a, 224b is not successful, neither transaction is recorded.

When a message is sent to a smart contract to record a transaction 224a, the message is sent to each node that maintains a replica of the blockchain 204. Each node executes the computer code of the smart contract to implement the transaction 224a. For example, if a hundred nodes each maintain a replica of the blockchain 204, the computer code executes at each of the hundred nodes. When a node completes execution of the computer code, the result of the transaction 224a is recorded in the blockchain 204. The nodes employ a consensus algorithm to decide which transactions (e.g., 224c) to keep and which transactions (e.g., 224d) to discard. Although the execution of the computer code at each node helps ensure the authenticity of the blockchain 204, large amounts of computer resources are required to support such redundant execution of computer code.

Although blockchains can effectively store transactions 224a-d, the large amount of computer resources, such as storage and computational power, needed to maintain all the replicas of the blockchain can be problematic. To overcome this problem, some systems for storing transactions 224a-d do not use blockchains, but rather have each party to a transaction maintain its own copy of the transaction 224a. One such system is the Corda™ system developed by R3™, which provides a decentralized distributed ledger platform in which each participant in the platform has a node (e.g., computer system) that maintains its portion of the distributed ledger.

When parties agree on the terms of a transaction 224a, a party submits the transaction 224a to a notary, which is a trusted node, for notarization. The notary maintains a consumed output database of transaction outputs that have been input into other transactions. When a transaction 224a is received, the notary checks the inputs to the transaction 224a against the consumed output database to ensure that the outputs referenced by the inputs have not been spent. If the inputs have not been spent, the notary updates the consumed output database to indicate that the referenced outputs have been spent, notarizes the transaction 224a (e.g., by signing the transaction or a transaction identifier with a private key of the notary), and sends the notarized transaction to the party that submitted the transaction 224a for notarization. When the party receives the notarized transaction, the party stores the notarized transaction and provides the notarized transaction to the counterparties.

In embodiments, a notary is a non-validating notary or a validating notary. When a non-validating notary is to notarize a transaction (e.g., 224b), the non-validating notary determines that the prior output of a prior transaction (e.g., 224a), that is, the input of the current transaction 224b, has not been consumed. If the prior output has not been consumed, the non-validating notary notarizes the transaction 224b by signing a hash 228b of the transaction. To notarize a transaction 224b, a non-validating notary needs only the identification of the prior output (e.g., the hash 228a of the prior transaction 224a and the index of the output) and the portion of the Merkle tree needed to calculate the hash 228b of the transaction 224b.

As described herein, in some embodiments, the blockchain system 200 uses one or more smart contracts to enable more complex transactions. For example, a validating notary validates a transaction (e.g., 224d), which includes verifying that prior transactions 224a-c in a backchain of transactions are valid. The backchain refers to the collection of prior transactions (e.g., 224c) of a transaction 224d, as well as prior transactions 224a-b of those prior transactions 224c, and so on. To validate a transaction 224d, a validating notary invokes validation code of the transaction 224d. In one example, a validating notary invokes validation code of a smart contract of the transaction 224d. The validation code performs whatever checks are needed to comply with the terms applicable to the transaction 224d. This checking may include retrieving the public key of the owner from the prior transaction 224c (pointed to by the input state of the transaction 224d), checking the signature of the transaction 224d to ensure that the prior output of a prior transaction that is input has not been consumed, and checking the validity of each prior transaction (e.g., 224c) in the backchain of the transactions. If the validation code indicates that the transaction 224d is valid, the validating notary notarizes the transaction 224d and records the output of the prior transaction 224c as consumed.

In some examples, to verify that the transactions 224a-d in a ledger stored at a node are correct, the blocks 204a-c in the blockchain 204 can be accessed from oldest 204a to newest 204c, generating a new hash of the block 204c and comparing the new hash to the hash 208c generated when the block 204c was created. If the hashes are the same, then the transactions in the block are verified. In one example, the bitcoin system also implements techniques to ensure that it would be infeasible to change a transaction 224a and regenerate the blockchain 204 by employing a computationally expensive technique to generate a nonce 220b that is added to the block when it is created. A bitcoin ledger is sometimes referred to as an Unspent Transaction Output (UTXO) set because it tracks the output of all transactions that have not yet been spent.

In some embodiments, a self-sovereign identity (SSI) approach to digital identity is used that gives individuals control over the information they use to prove who they are to websites, services, and applications across the web. In an SSI system, the user accesses services in a streamlined and secure manner, while maintaining control over the information associated with their identity. SSI addresses the difficulty of establishing trust in an interaction. In order to be trusted, one party in an interaction will present credentials to the other parties, and those parties can verify that the credentials came from an issuer that they trust. In this way, the verifier's trust in the issuer is transferred to the credential holder. This basic structure of SSI with three participants is sometimes called “the trust triangle.” For an identity system to be self-sovereign, users control the verifiable credentials that they hold and their consent is required to use those credentials. This reduces the unintended sharing of users' personal data.

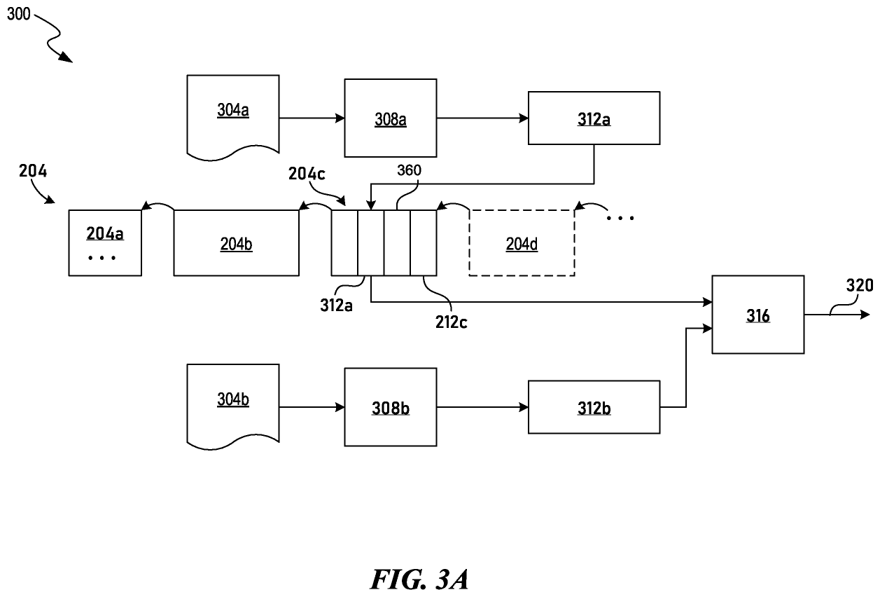

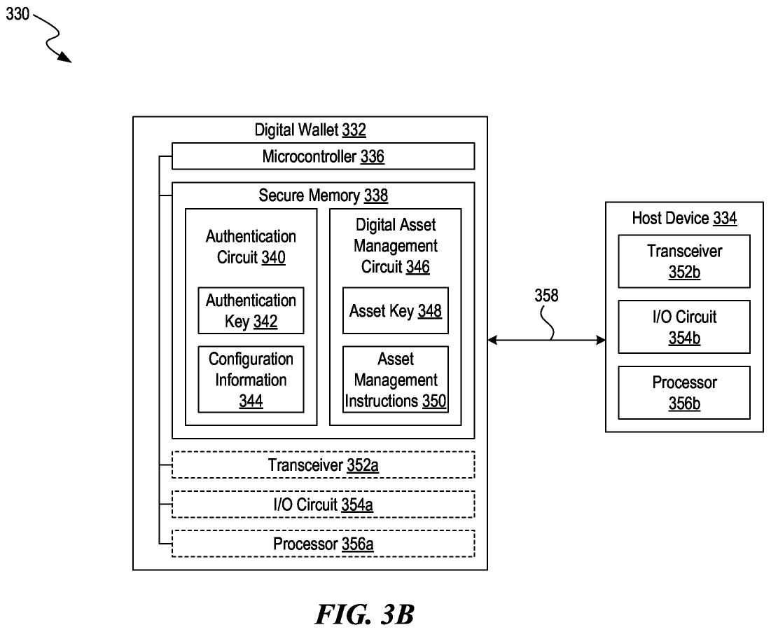

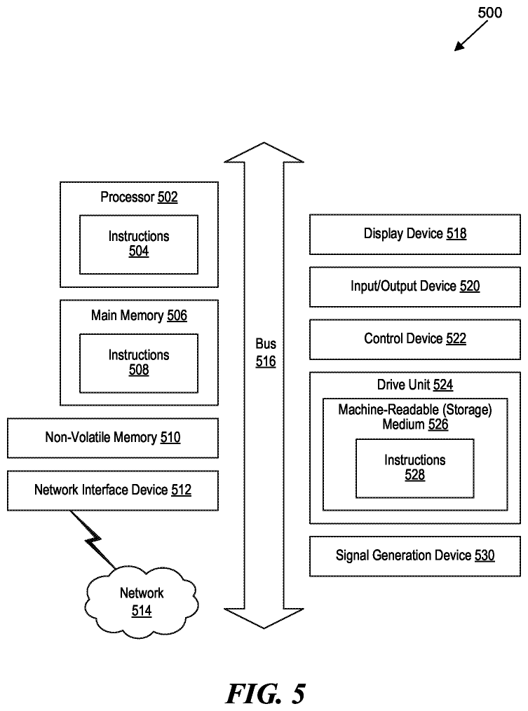

FIG. 3A illustrates a process 300 that uses a hash algorithm to generate an NFT or perform a cryptographic transaction on a blockchain. An exemplary blockchain 204, e.g., as shown in FIG. 3A, is also illustrated and described in detail with reference to FIG. 2. The process 300 can be performed by a computer system such as that described with reference to FIG. 5 and/or by nodes of the blockchain 204. Some embodiments include different and/or additional steps or perform steps in different orders.

In embodiments, digital content 304a comprising a digital message, electronic art, a digital collectible, any other form of digital content, or a combination thereof may be hashed using hashing algorithm 308a. The hashing algorithm 308a (sometimes referred to as a “hash function”) may be a function used to map data of arbitrary size (e.g., content 304a) to fixed-size values (e.g., hash 312a). The values 312a that are returned by the hash function 308a can be called hash values, hash codes, digests, or hashes. The values 312a can be used to index a fixed-size table called a hash table. A hash table, also known as a hash map, is a data structure that implements an associative array or dictionary, which is an abstract data type that maps keys (e.g., content 304a) to values 312a.

The output of the hashed content 304a (e.g., hash 312a) can be inserted into a block (e.g., block 204c) of the blockchain 204 (e.g., comprising blocks such as blocks 204a-d). The block 204c can include, among other things, information such as timestamp 212c. In order to verify that the block 204c is correct, a new hash 312b is generated by applying hashing algorithm 308b to the digital content 304b. The new hash 312b is compared to the hash 312a in the blockchain 204 at comparison step 316. If the new hash 312b is the same as the hash 312a of the block 204c, the comparison yields an indication that they match. For example, the decision 320 can indicate that the hashes 312a-b are the same or not. The hashes can be indicated to be the same if the characters of the hash match. The hashing algorithms 308a-b can include any suitable hashing algorithm. Examples include Message Digest 5 (MD5), Secure Hashing Algorithm (SHA), and/or the like.

Components of the process 300 can generate or validate an NFT, which is a cryptographic asset that has a unique identification code and metadata that uniquely identifies the NFT. In one example, the digital content 304a can be hashed and minted to generate an NFT, or the content 304a can represent an NFT that is verified using the process 300 and the content 304b. An NFT can include digital data (e.g., 312a) stored in the blockchain 204. The ownership of an NFT (e.g., 360) is recorded in the blockchain 204 and is transferable by an owner, allowing the NFT 360 to be sold and traded. The NFT 360 contains a reference to digital files such as photos, videos, or audio (e.g., content 304a). Because NFTs are uniquely identifiable assets, they differ from cryptocurrencies, which are fungible. In particular, NFTs function like cryptographic tokens, but unlike cryptocurrencies such as bitcoin or Ethereum™, NFTs are not mutually interchangeable, and so are not fungible.

The NFT can be associated with a particular digital or physical asset such as an image, a work of art, a piece of music, or a clip of a sports highlight (e.g., content 304a) and can confer licensing rights to use the asset 304a for a specified purpose. As with other assets, NFTs are recorded on a blockchain when a blockchain 204 concatenates records containing cryptographic hashes-sets of characters that identify a set of data-onto previous records, creating a chain of identifiable data blocks 204a-d. A cryptographic transaction process enables authentication of each digital file by providing a digital signature that tracks NFT ownership. In embodiments, a data link that is part of the NFT records points to details about where the associated art (content 304a) is stored.

Minting an NFT (e.g., 360) may refer to the process of turning a digital file (e.g., 304a) into a crypto collectible or digital asset 360 on blockchain 204 (e.g., the Ethereum™ blockchain). The digital item or file 304a may be stored in the blockchain 204 and may not be capable of being edited, modified, or deleted. The process of uploading a specific item onto the blockchain 204 is known as “minting.” For example, “NFT minting” can refer to a process by which a digital artwork or digital content 304a becomes a part of the Ethereum™ blockchain. Thus, the process turns digital content 304a into a crypto asset 360, which is easily traded or bought with cryptocurrencies on a digital marketplace without an intermediary.

FIG. 3B is a block diagram of a process 330 illustrating an example digital wallet device. In particular, a digital wallet (“wallet”) 332 is an electronic entity that allows users to securely manage digital assets. According to various embodiments, the digital wallet 332 can be a hardware-based wallet (e.g., can include dedicated hardware component(s)), a software-based wallet, or a combination thereof. Example digital assets that can be stored and managed using the digital wallet 332 include digital coins, digital tokens, and/or the like. In some embodiments, tokens are stored on a blockchain system, such as the blockchain system 200 described in FIG. 2. In some embodiments, the digital wallet 332 may be capable of connecting to and managing digital assets that are native to or associated with different blockchain systems 200.

As defined herein, the terms “coin” and “token” refer to a digital representation of a particular asset, utility, ownership interest, and/or access right. Any suitable type of coin or token can be managed using various embodiments of the digital wallet 332. In some embodiments, tokens include cryptocurrency, such as exchange tokens and/or stablecoins. Exchange tokens and/or stablecoins can be native to a particular blockchain system 200 and, in some instances, can be backed by a value-stable asset, such as fiat currency, precious metal, oil, or another commodity. In some embodiments, tokens are utility tokens that provide access to a product or service rendered by an operator of the blockchain system 200 (e.g., a token issuer). In some embodiments, tokens are security tokens, which can be securitized cryptocurrencies that derive from a particular asset, such as bonds, stocks, real estate, and/or fiat currency, or a combination thereof, and can represent an ownership right in an asset or in a combination of assets.

In some embodiments, tokens are NFTs or other non-fungible digital certificates of ownership, or decentralized finance (DeFi) tokens. DeFi tokens can be used to access feature sets of DeFi software applications (dApps) built on the blockchain system 200. Example dApps can include decentralized lending applications (e.g., Aave), decentralized cryptocurrency exchanges (e.g., Uniswap), decentralized NFT marketplaces (e.g., OpenSea, Rarible), decentralized gaming platforms (e.g., Upland), decentralized social media platforms (e.g., Steemit), decentralized music streaming platforms (e.g., Audius), and/or the like. In some embodiments, tokens provide access rights to various computing systems and can include authorization keys, authentication keys, passwords, personal identification numbers (PINs), biometric information, access keys, and other similar information. The computing systems to which the tokens provide access can be either on-chain (e.g., implemented as dApps on a particular blockchain system 200) or off-chain (e.g., implemented as computer software on computing devices that are separate from the blockchain system 200).

The digital wallet 332 can be embodied in a device that is communicatively coupled to a host device 334 (e.g., a mobile phone, a laptop, a tablet, a desktop computer, a wearable device, a point-of-sale (POS) terminal, an automated teller machine (ATM), and the like) via a communication link 358. In some embodiments, the host device 334 can extend the feature set available to the user of the digital wallet 332 when the digital wallet is coupled to the host device 334. For instance, the host device 334 may provide the user with the ability to perform balance inquiries, convert tokens, access exchanges and/or marketplaces, perform transactions, access computing systems, and/or the like.

In some embodiments, the digital wallet 332 and the host device 334 can be owned and/or operated by the same entity, user, or a group of users. For example, an individual owner of the digital wallet 332 can also operate a personal computing device that acts as a host device 334 and provides enhanced user experience relative to the digital wallet 332 (e.g., by providing a user interface that includes graphical features, an immersive reality experience, a virtual reality experience, or similar). In some embodiments, the digital wallet 332 and the host device 334 can be owned and/or operated by different entities, users, and/or groups of users. For example, the host device 334 can be a POS terminal at a merchant location, and the individual owner of the digital wallet 332 can use the digital wallet 332 as a method of payment for goods or services at the merchant location by communicatively coupling the two devices for a short period of time (e.g., via chip, via near-field communications (NFC), by scanning of a bar code, by causing the digital wallet 332 to generate and display a quick response (QR) code) to transmit payment information from the digital wallet 332 to the host device 334.

The digital wallet 332 and the host device 334 can be physically separate and/or capable of being removably coupled. The ability to physically and communicatively uncouple the digital wallet 332 from the host device 334 and other devices enables the air-gapped digital wallet 332 to act as “cold” storage, where the stored digital assets are moved offline and become inaccessible to the host device 334 and other devices. Air-gapped wallets are bitcoin wallets completely disconnected from the internet and any form of wireless communication. Further, the ability to physically and communicatively uncouple the digital wallet 332 from the host device 334 allows the digital wallet 332 to be implemented as a larger block of physical memory, which extends the storage capacity of the digital wallet 332, similar to a safety deposit box or vault at a brick-and-mortar facility.

Accordingly, in some embodiments, the digital wallet 332 and the host device 334 are physically separate entities. In such embodiments, the communication link 358 can include a computer network. For instance, the digital wallet 332 and the host device 334 can be paired wirelessly via a short-range communications protocol (e.g., Bluetooth, Zigbee, infrared communication) or via another suitable network infrastructure. In some embodiments, the digital wallet 332 and the host device 334 are removably coupled. For instance, the host device 334 can include a physical port, outlet, opening, or similar to receive and communicatively couple to the digital wallet 332, directly or via a connector.

In some embodiments, the digital wallet 332 can include or be stored on a tangible storage media, such as a dynamic random-access memory (DRAM) stick, a memory card, a secure digital (SD) card, a flash drive, a solid state drive (SSD), a magnetic hard disk drive (HDD), an optical disc, and/or the like and can connect to the host device via a suitable interface, such as a memory card reader, a universal serial bus (USB) port, a micro-USB port, an external Serial Advanced Technology Attachment (eSATA) port, and/or the like.

In some embodiments, the digital wallet 332 can include or be stored on an integrated circuit, such as a Subscriber Identity Module (SIM) card, a smart cart, and/or the like. For instance, in some embodiments, the digital wallet 332 can be a physical smart card that includes an integrated circuit, such as a chip that can store data. In some embodiments, the digital wallet 332 is a contactless physical smart card. Advantageously, such embodiments enable data from the card to be read by a host device as a series of application protocol data units (APDUs) according to a conventional data transfer protocol between payment cards and readers (e.g., ISO/IEC 7816), which enhances interoperability between the cryptographic payment ecosystem and payment card terminals.

In some embodiments, the digital wallet 332 and the host device 334 are non-removably coupled. For instance, various components of the digital wallet 332 can be co-located with components of the host device 334 in the housing of the host device 334. In such embodiments, the host device 334 can be a mobile device, such as a phone, a wearable device, or similar, and the digital wallet 332 can be built into the host device. The integration between the digital wallet 332 and the host device 334 can enable improved user experience and extend the feature set of the digital wallet 332 while preserving computing resources (e.g., by sharing the computing resources, such as transceiver, processor, and/or display or the host device 334). The integration further enables the ease of asset transfer between parties. The integration can further enhance loss protection options, as recovering a password or similar authentication information, rather than recovering a physical device, can be sufficient to restore access to digital assets stored in the digital wallet 332. In some embodiments, the non-removably coupled digital wallet 332 can be air-gapped by, for example, disconnecting the host device 334 from the Internet.

As shown, the digital wallet 332 can include a microcontroller 336. The microcontroller 336 can include or be communicatively coupled to (e.g., via a bus or similar communication pathway) at least a secure memory 338. The digital wallet 332 can further include a transceiver 352a, an input/output circuit 354a, and/or a processor 356a. In some embodiments, however, some or all of these components can be omitted.

In some embodiments, the digital wallet 332 can include a transceiver 352a and therefore can be capable of independently connecting to a network and exchanging electronic messages with other computing devices. In some embodiments, the digital wallet 332 does not include a transceiver 352a. The digital wallet 332 can be capable of connecting to or being accessible from a network, via a transceiver 352b of the host device 334, when the digital wallet 332 is docked to the host device 334. For example, in some embodiments, the user of the digital wallet 332 can participate in token exchange activities on decentralized exchanges when the digital wallet 332 is connected to the host device 334.

In some embodiments, the digital wallet 332 can include an input/output circuit 354a, which may include user-interactive controls such as buttons, sliders, gesture-responsive controls, and/or the like. The user-interactive controls can allow a user of the digital wallet 332 to interact with the digital wallet 332 (e.g., perform balance inquiries, convert tokens, access exchanges and/or marketplaces, perform transactions, access computing systems, and/or the like). In some embodiments, the user can access an expanded feature set, via an input/output circuit 354b of the host device 334, when the digital wallet 332 is docked to the host device 334. For example, the host device 334 can include computer-executable code structured to securely access data from the digital wallet 332 and to perform operations using the data. The data can include authentication information, configuration information, asset keys, and/or token management instructions. The data can be used by an application that executes on or is executed by the host device 334. The data can be used to construct application programming interface (API) calls to other applications that require or use the data provided by the digital wallet 332. Other applications can include any on-chain or off-chain computer applications, such as dApps (e.g., decentralized lending applications, decentralized cryptocurrency exchanges, decentralized NFT marketplaces, decentralized gaming platforms, decentralized social media platforms, decentralized music streaming platforms), third-party computing systems (e.g., financial institution computing systems, social networking sites, gaming systems, online marketplaces), and/or the like.

The secure memory 338 is shown to include an authentication circuit 340 and a digital asset management circuit 346. The authentication circuit 340 and/or the digital asset management circuit 346 include computer-executable code that, when executed by one or more processors, such as one or more processors 356a and/or 356b, performs specialized computer-executable operations. For example, the authentication circuit 340 can be structured to cause the digital wallet 332 to establish, maintain, and manage a secure electronic connection with another computing device, such as the host device 334. The digital asset management circuit 346 can be structured to cause the digital wallet 332 to allow a user to manage the digital assets accessible via the digital wallet 332. In some embodiments, the authentication circuit 340 and the digital asset management circuit 346 are combined in whole or in part.

As shown, the authentication circuit 340 can include retrievably stored security, authentication, and/or authorization data, such as an authentication key 342. The authentication key 342 can be a numerical, alphabetic, or alphanumeric value or combination of values. The authentication key 342 can serve as a security token that enables access to one or more computing systems, such as the host device 334. For instance, in some embodiments, when the digital wallet 332 is paired with or docked to (e.g., establishes an electronic connection with) the host device 334, the user may be prompted to enter authentication information via the input/output circuit(s) 354a and/or 354b. The authentication information may include a PIN, a password, a pass phrase, biometric information (e.g., fingerprint, a set of facial features, a retinal scan), a voice command, and/or the like. The authentication circuit 340 can compare the user-entered information to the authentication key 342 and maintain the electronic connection if the items match at least in part.

As shown, the authentication circuit 340 can include retrievably stored configuration information 344. The configuration information 344 can include a numerical, alphabetic, or alphanumeric value or combination of values. These items can be used to enable enhanced authentication protocols. For instance, the configuration information 344 can include a timeout value for an authorized connection between the digital wallet 332 and the host device 334. The configuration information 344 can also include computer-executable code. In some embodiments, for example, where a particular digital wallet 332 is set up to pair with only one or a small number of pre-authorized host devices 334, the configuration information 344 can include a device identifier and/or other device authentication information, and the computer-executable code may be structured to verify the device identifier and/or other device authentication information against the information associated with or provided by the host device 334. When a pairing is attempted, the computer-executable code may initiate or cause the host device 334 to initiate an electronic communication (e.g., an email message, a text message) using user contact information stored as configuration information 344.

As shown, the digital asset management circuit 346 can include retrievably stored digital asset data, such as an asset key 348. The asset key 348 can be a numerical, alphabetic, or alphanumeric value or combination of values. In some embodiments, the asset key 348 is a private key in a public/private key pair, a portion thereof, or an item from which the private key can be derived. Accordingly, the asset key 348 proves ownership of a particular digital asset stored on a blockchain system 200. The asset key 348 can allow a user to perform blockchain transactions involving the digital asset. The blockchain transactions can include computer-based operations to earn, lend, borrow, long/short, earn interest, save, buy insurance, invest in securities, invest in stocks, invest in funds, send and receive monetary value, trade value on decentralized exchanges, invest and buy assets, sell assets, and/or the like. The digital wallet 332 can be identified as a party to a blockchain transaction on the blockchain system 200 using a unique cryptographically generated address (e.g., the public key in the public/private key pair).

As shown, the digital asset management circuit 346 can also include retrievably stored asset management instructions 350. The asset management instructions 350 can include a numerical, alphabetic, or alphanumeric value or combination of values. These items can be used to enable computer-based operations related to managing digital assets identified by the asset key 348. For instance, the asset management instructions 350 can include parameter values, metadata, and/or similar values associated with various tokens identified by the asset key 348 and/or by the blockchain systems 200 associated with particular tokens. The asset management instructions 350 can also include computer-executable code. In some embodiments, for example, asset management functionality (e.g., balance inquiry and the like) can be executable directly from the digital wallet 332 rather than or in addition to being executable from the host device 334.

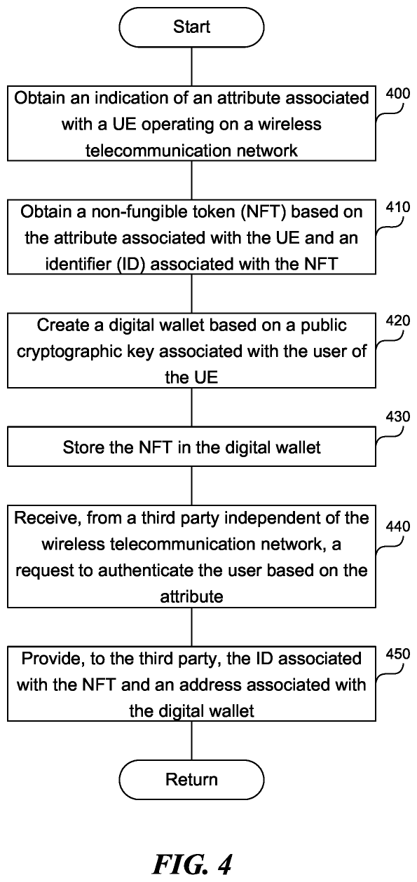

FIG. 4 is a flowchart of a method to authenticate a user of a wireless telecommunication network based on an NFT indicating an attribute associated with a UE operating on the wireless telecommunication network. The described method can be implemented using Web 3.0. Web 3.0 is the next generation of the web, in which most users will be connected via a decentralized network and have access to their own data. A hardware or software processor executing instructions described in this application can, in step 400, obtain an indication of an attribute associated with a UE operating on a wireless telecommunication network, where the attribute can include a phone number associated with the UE, an International Mobile Equipment Identity (IMEI) associated with the UE, a unique identifier (ID) associated with a user of the UE, a coupon, a promotion, a subscription plan, a bill, etc.

In step 410, the processor can obtain an NFT based on the attribute associated with the UE, an ID associated with the NFT, and a private cryptographic key associated with the user of the mobile device. The NFT can be publicly readable or can be encrypted using the user's public cryptographic key. If encrypted, only the user can decrypt the NFT because only the user knows the corresponding private cryptographic key.

The public cryptographic key corresponds to the digital wallet address, and is akin to a mailbox on the blockchain. When UE owns an NFT, it means the address of the digital wallet is registered on the blockchain as the owner of that NFT. The NFT itself, identified by its unique token ID, is stored on the blockchain. The digital wallet is the address associated with the NFT's ownership.

The private cryptographic key is akin to a key to the mailbox. The private cryptographic key allows the UE owning the NFT to access the digital wallet and make transactions, such as transferring ownership of an NFT to another wallet. When a transaction is made, the transaction is “signed” with the private cryptographic key, which is a way of proving that the transaction is authorized by the holder of the private cryptographic key.

The token ID is a unique identifier for each NFT. The blockchain differentiates one NFT from another using the token ID. When an NFT is purchased or minted, a record is created on the blockchain that associates the token ID of the NFT with the digital wallet's address that has purchased or minted the NFT.

The NFT can include metadata such as images, descriptions, audio, etc. The metadata of the NFT usually contains information about the asset it represents. Metadata usually does not contain information about the owner of the NFT. The NFT can be stored in the blockchain, or the block chain can store a token that points to the NFT. The NFT can be stored in a decentralized file system such as IPFS.

When a system accesses a digital wallet, the digital wallet shows the NFTs “in” the digital wallet, however, the wallet is interacting with the blockchain to show the NFTs that the wallet's keys have control over. The wallet can retrieve the metadata of the NFTs belonging to the wallet from the NFT's off-chain storage location, e.g. IPFS, and display the metadata in a user-friendly way.

When an NFT is minted, the NFT is usually associated with a digital wallet, which is essentially an address on the blockchain. This wallet is the owner of the NFT. The ownership of the NFT is created by a storing in a smart contract of the NFT, the address of the digital wallet and the ID associated with the NFT.

The NFT-ownership information is stored on the blockchain and can be found by querying the smart contract of the NFT with the idea of the NFT. A blockchain explorer that supports the specific blockchain where the NFT is minted (e.g., Etherscan for Ethereum) can find out which wallet owns which NFT. The blockchain explorer can receive as input a contract address associated with the NFT and an ID associated with the NFT, and provide the current owner of the NFT. Contract Address refers to the address where the contract is deployed on the blockchain (e.g., Ethereum), while ID associated with the NFT refers to this specific NFT.

In step 420, the processor can create a digital wallet based on a public cryptographic key associated with the user of the UE, where the digital wallet is configured to store a private cryptographic key associated with a user of the UE operating on the wireless telecommunication network. The public cryptographic key can correspond to the private cryptographic key, and an address of the digital wallet can correspond to the public cryptographic key. Storing of the private cryptographic key in the digital wallet indicates that the owner of the wallet owns the NFT. The private cryptographic key can be a private cryptographic key to the blockchain address of the NFT.

In step 430, the processor can store the private cryptographic key in the digital wallet. Storing the private cryptographic key in the digital wallet indicates that the attribute included in the NFT belongs to the user of the UE.

In step 440, the processor can receive, from a third party independent of the wireless telecommunication network, a request to authenticate the user based on the attribute. The third party can be a partner of the wireless telecommunication network that doesn't have access to the internal databases of the wireless telecommunication network, but that can be associated with the NFT, such as a coupon provider.

In step 450, the processor can provide, to the third party, the ID associated with the NFT and an address associated with the digital wallet. The address associated with the digital wallet can be the public cryptographic key of the user, or the address can be uniquely derivable from the public cryptographic key. The third party can authenticate the user upon verifying that the private cryptographic key is stored in the digital wallet corresponding to the public cryptographic key associated with the user.

The processor can tokenize, e.g., convert to an NFT, the UE ID such as an IMEI, and use the NFT to track ownership of the phone. For example, the processor can check whether the phone is stolen. The processor can receive the request from the third party independent of the wireless telecommunication network to authenticate the user based on the attribute, where the attribute includes the IMEI associated with the UE, and where the request includes verifying whether the UE is stolen. The processor can cause the third party to determine whether the UE is stolen by determining whether the private cryptographic key is stored in the digital wallet associated with the user. Upon determining that the private cryptographic key is not stored in the digital wallet associated with the user, the processor can cause the third party to determine that the UE is stolen. Upon determining that the private cryptographic key is stored in the digital wallet associated with the user, the processor can cause the third party to determine that the UE belongs to the user.

The processor can obtain the indication of the attribute associated with the UE operating on the wireless telecommunication network, where the attribute includes an incentive to engage with the third party. The incentive can be a coupon on a particular day of the week, such as Tuesday, associated with the third party, e.g., a business close to the user such as a burger discount, free movie tickets, or a discount on mobile phones. The wireless telecommunication network can determine the UE location, and the surrounding businesses to provide the coupons. The processor can store the coupon as an NFT. The processor can cause the third party to determine whether the user is associated with the incentive by determining whether the private cryptographic key is stored in the digital wallet associated with the user. Upon determining that the private cryptographic key is not stored in the digital wallet associated with the user, the processor can cause the third party to determine that the user is not associated with the incentive. Upon determining that the private cryptographic key is stored in the digital wallet associated with the user, the processor can cause the third party to determine that the user is associated with the incentive.

The processor can obtain the indication of the attribute associated with the UE operating on the wireless telecommunication network, where the attribute includes information associated with the wireless telecommunication network, and where the information indicates an action to be performed by the UE. The information can be a bill from the wireless telecommunication network, and the action to be performed by the UE can be a payment of the bill. The processor can cause the NFT to be encrypted using the public cryptographic key associated with the user, thereby making the NFT unreadable to the public. The processor can obtain the information contained in the NFT by decrypting the NFT using the private cryptographic key associated with the user. The processor can perform the action.

The processor can convert a unique ID of the user of the wireless telecommunication network to an NFT so that the user's unique ID can be verified by third parties unaffiliated with the wireless telecommunication network, such as third parties in foreign countries. The third parties can access a public blockchain storing the NFT to make the verification. Specifically, the processor can obtain the indication of the attribute associated with the UE operating on the wireless telecommunication network, where the unique ID associated with the user indicates that the user is associated with the wireless telecommunication network. The processor can cause the third party to determine whether the user is associated with the wireless telecommunication network by determining whether the private cryptographic key is stored in the digital wallet associated with the user. The third party can be a partner of the wireless telecommunication network that does not have access to the private databases of the wireless telecommunication network. Upon determining that the private cryptographic key is not stored in the digital wallet associated with the user, the processor can cause the third party to determine that the user is not associated with the wireless telecommunication network. Upon determining that the private cryptographic key is stored in the digital wallet associated with the user, the processor can cause the third party to determine that the user is associated with the wireless telecommunication network. Upon verification, the third party can provide benefits to the user, such as a discounted service, access to a walled website, access to secure information, etc.

The processor can tokenize, e.g., convert to NFT, premium phone numbers, such as 777-7777, and trade them as an NFT. Specifically, the processor can obtain the indication of the attribute associated with the UE operating on the wireless telecommunication network, where the attribute includes an easy-to-remember phone number associated with the UE. The processor can cause creation of the NFT including the easy-to-remember phone number. The processor can receive a request from a second UE associated with the wireless telecommunication network to transfer the NFT including the easy-to-remember phone number. The processor can change a phone number associated with the second UE by transferring the NFT including the easy-to-remember phone number to a second digital wallet associated with the second UE.

The processor can record an Embedded Subscriber Identity Module (eSIM) associated with the UE in an NFT. The processor can obtain the indication of the attribute associated with the UE operating on the wireless telecommunication network, where the attribute includes the eSIM associated with the UE. The processor can cause the third party to determine whether the UE is associated with the eSIM by determining whether the private cryptographic key is stored in the digital wallet associated with the user. The third party can be a partner of the wireless telecommunication network that does not have access to the private databases of the wireless telecommunication network. Upon determining that the private cryptographic key is not stored in the digital wallet associated with the user, the processor can cause the third party to determine that the UE is not associated with the eSIM. Upon determining that the private cryptographic key is stored in the digital wallet associated with the user, the processor can cause the third party to determine that the UE is associated with the eSIM. Upon verification, the third party can provide benefits to the user, such as a discounted service, access to a walled website, access to secure information, etc.

The processor can record the NFT in a public blockchain, where the public blockchain allows the third party to access the NFT when the third party does not have access to a database associated with the wireless telecommunication network which stores the attribute.

### Computer System

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a display device 518, an input/output device 520, a control device 522 (e.g., keyboard and pointing device), a drive unit 524 that includes a storage medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computer system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 500. In some implementations, the computer system 500 can be an embedded computer system, a system-on-chip (SOC), a single-board computer system (SBC), or a distributed system such as a mesh of computer systems, or can include one or more cloud components in one or more networks. Where appropriate, one or more computer systems 500 can perform operations in real time, in near real time, or in batch mode.

The network interface device 512 enables the computer system 500 to mediate data in a network 514 with an entity that is external to the computer system 500 through any communication protocol supported by the computer system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computer system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computer system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense-that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A non-transitory, computer-readable storage medium comprising instructions recorded thereon to authenticate a user of a wireless telecommunication network based on a non-fungible token (NFT) indicating an attribute associated with a mobile device operating on the wireless telecommunication network, wherein the instructions, when executed by at least one processor of a system of the wireless telecommunication network, cause the system to:
obtain an indication of the attribute associated with the mobile device operating on the wireless telecommunication network,
wherein the attribute includes at least two of: a phone number associated with the mobile device, an International Mobile Equipment Identity (IMEI) associated with the mobile device, International mobile subscriber identity (IMSI), or a unique identifier (ID) associated with the user of the mobile device;
obtain the NFT including the attribute associated with the mobile device, an ID associated with the NFT, and a private cryptographic key associated with the user of the mobile device; create a digital wallet based on a public cryptographic key associated with the user of the mobile device, wherein the public cryptographic key corresponds to the private cryptographic key,
wherein an address of the digital wallet corresponds to the public cryptographic key, and
wherein the digital wallet is configured to store the NFT and a private cryptographic key associated with the user of the mobile device operating on the wireless telecommunication network;
store the private cryptographic key in the digital wallet,
wherein the private cryptographic key provides access to the NFT and indicates that the attribute included in the NFT belongs to the user of the mobile device;
receive a request from a third party independent of an operator of the wireless telecommunication network to authenticate the user based on the attribute; and
provide, to the third party, the ID associated with the NFT and the public cryptographic key associated with the user,
wherein the third party authenticates the user upon verifying that the private cryptographic key is stored in the digital wallet corresponding to the public cryptographic key associated with the user.

2. The non-transitory, computer-readable storage medium of claim 1, comprising instructions to:
receive the request from the third party independent of the wireless telecommunication network to authenticate the user based on the attribute, wherein the attribute includes the IMEI associated with the mobile device, wherein the request includes verifying whether the mobile device is stolen;
cause the third party to determine whether the mobile device is stolen by determining whether the private cryptographic key is stored in the digital wallet associated with the user;
upon determining that the private cryptographic key is not stored in the digital wallet associated with the user, cause the third party to determine that the mobile device is stolen; and
upon determining that the private cryptographic key is stored in the digital wallet associated with the user, cause the third party to determine that the mobile device belongs to the user.

3. The non-transitory, computer-readable storage medium of claim 1, comprising instructions to:
obtain the indication of the attribute associated with the mobile device operating on the wireless telecommunication network, wherein the attribute includes an incentive to engage with the third party, wherein the incentive includes a coupon associated with the third party;
cause the third party to determine whether the user is associated with the incentive by determining whether the private cryptographic key is stored in the digital wallet associated with the user;
upon determining that the private cryptographic key is not stored in the digital wallet associated with the user, cause the third party to determine that the user is not associated with the incentive; and
upon determining that the private cryptographic key is stored in the digital wallet associated with the user, cause the third party to determine that the user is associated with the incentive.

4. The non-transitory, computer-readable storage medium of claim 1, comprising instructions to:
obtain the indication of the attribute associated with the mobile device operating on the wireless telecommunication network,
wherein the attribute includes information associated with the wireless telecommunication network,
wherein the information indicates an action to be performed by the mobile device;
cause the NFT to be encrypted using the public cryptographic key associated with the user, thereby making the NFT unreadable to public users;
obtain the information contained in the NFT by decrypting the NFT using the private cryptographic key associated with the user; and
perform the action.

5. The non-transitory, computer-readable storage medium of claim 1, comprising instructions to:
obtain the indication of the attribute associated with the mobile device operating on the wireless telecommunication network,
wherein the unique ID associated with the user indicates that the user is associated with the wireless telecommunication network;
cause the third party to determine whether the user is associated with the wireless telecommunication network by determining whether the private cryptographic key is stored in the digital wallet associated with the user;
upon determining that the private cryptographic key is not stored in the digital wallet associated with the user, cause the third party to determine that the user is not associated with the wireless telecommunication network; and
upon determining that the private cryptographic key is stored in the digital wallet associated with the user, cause the third party to determine that the user is associated with the wireless telecommunication network.

6. The non-transitory, computer-readable storage medium of claim 1, comprising instructions to:
obtain the indication of the attribute associated with the mobile device operating on the wireless telecommunication network,
wherein the attribute includes an easy-to-remember phone number associated with the mobile device;
cause creation of the NFT including the easy-to-remember phone number;
receive a request from a second mobile device associated with the wireless telecommunication network to transfer the NFT including the easy-to-remember phone number; and
change a phone number associated with the second mobile device by transferring the NFT including the easy-to-remember phone number to a second digital wallet associated with the second mobile device.

7. The non-transitory, computer-readable storage medium of claim 1, comprising instructions to:
obtain the indication of the attribute associated with the mobile device operating on the wireless telecommunication network,
wherein the attribute includes an Embedded Subscriber Identity Module (eSIM) associated with the mobile device;
cause the third party to determine whether the mobile device is associated with the eSIM by determining whether the private cryptographic key is stored in the digital wallet associated with the mobile device;
upon determining that the private cryptographic key is not stored in the digital wallet associated with the mobile device, cause the third party to determine that the mobile device is not associated with the eSIM; and
upon determining that the private cryptographic key is stored in the digital wallet associated with the mobile device, cause the third party to determine that the mobile device is associated with the eSIM.

8. The non-transitory, computer-readable storage medium of claim 1, comprising instructions to:
store the NFT in a block on a blockchain;
generate a hash of contents of the block by generating a hash of a root node of a Merkle tree associated with the contents of the block; and
store the hash of contents in the block.

9. A method comprising:
obtaining an indication of an attribute associated with a UE operating on a wireless telecommunication network,
wherein the attribute includes a phone number associated with the UE, an International Mobile Equipment Identity (IMEI) associated with the UE, International mobile subscriber identity (IMSI), or a unique identifier (ID) associated with a user of the UE;
obtaining a non-fungible token (NFT) including the attribute associated with the UE, an ID associated with the NFT, and a private cryptographic key associated with the user of the UE;
creating a digital wallet based on a public cryptographic key associated with the user of the UE,
wherein the digital wallet is configured to store the private cryptographic key and a private cryptographic key associated with the user of the UE operating on the wireless telecommunication network;
storing the private cryptographic key in the digital wallet,
wherein storing the private cryptographic key indicates that the attribute included in the NFT belongs to the user of the UE;
receiving, from a third party independent of the wireless telecommunication network, a request to authenticate the user based on the attribute; and
providing, to the third party, the ID associated with the NFT and an address associated with the digital wallet,
wherein the third party authenticates the user upon verifying that the private cryptographic key is stored in the digital wallet.

10. The method of claim 9, comprising:
receiving the request from the third party independent of the wireless telecommunication network to authenticate the user based on the attribute, wherein the attribute includes the IMEI associated with the UE, wherein the request includes verifying whether the UE is stolen;
causing the third party to determine whether the UE is stolen by determining whether the private cryptographic key is stored in the digital wallet associated with the user;
upon determining that the private cryptographic key is not stored in the digital wallet associated with the user, causing the third party to determine that the UE is stolen; and
upon determining that the private cryptographic key is stored in the digital wallet associated with the user, causing the third party to determine that the UE belongs to the user.

11. The method of claim 9, comprising:
obtaining the indication of the attribute associated with the UE operating on the wireless telecommunication network,
wherein the attribute includes an incentive to engage with the third party,
wherein the incentive includes a coupon associated with the third party;
causing the third party to determine whether the user is associated with the incentive by determining whether the private cryptographic key is stored in the digital wallet associated with the user;
upon determining that the private cryptographic key is not stored in the digital wallet associated with the user, causing the third party to determine that the user is not associated with the incentive; and
upon determining that the private cryptographic key is stored in the digital wallet associated with the user, causing the third party to determine that the user is associated with the incentive.

12. The method of claim 9, comprising:
obtaining the indication of the attribute associated with the UE operating on the wireless telecommunication network,
wherein the unique ID associated with the user indicates that the user is associated with the wireless telecommunication network;
causing the third party to determine whether the user is associated with the wireless telecommunication network by determining whether the private cryptographic key is stored in the digital wallet associated with the user;
upon determining that the private cryptographic key is not stored in the digital wallet associated with the user, causing the third party to determine that the user is not associated with the wireless telecommunication network; and
upon determining that the private cryptographic key is stored in the digital wallet associated with the user, causing the third party to determine that the user is associated with the wireless telecommunication network.

13. The method of claim 9, comprising:
obtaining the indication of the attribute associated with the UE operating on the wireless telecommunication network,
wherein the attribute includes an easy-to-remember phone number associated with the UE;
causing creation of the NFT including the easy-to-remember phone number;
receiving a request from a second UE associated with the wireless telecommunication network to transfer the NFT including the easy-to-remember phone number; and
changing a phone number associated with the second UE by transferring the NFT including the easy-to-remember phone number to a second digital wallet associated with the second UE.

14. A system comprising:
at least one hardware processor; and
at least one non-transitory memory storing instructions, which, when executed by the at least one hardware processor, cause the system to:
obtain an indication of an attribute associated with a UE operating on a wireless telecommunication network,
wherein the attribute includes a phone number associated with the UE, an International Mobile Equipment Identity (IMEI) associated with the UE, International mobile subscriber identity (IMSI), or a unique identifier (ID) associated with a user of the UE;
obtain a non-fungible token (NFT) including the attribute associated with the UE,an ID associated with the NFT, and a private cryptographic key associated with the user of the UE;
create a digital wallet based on a public cryptographic key associated with the user of the UE,
wherein the digital wallet is configured to store the private cryptographic key and a private cryptographic key associated with the user of the UE operating on the wireless telecommunication network;
store the private cryptographic key in the digital wallet,
wherein storing the NFT indicates that the attribute included in the NFT belongs to the user of the UE;
receive, from a third party independent of the wireless telecommunication network, a request to authenticate the user based on the attribute; and
provide, to the third party, the ID associated with the NFT and an address associated with the digital wallet,
wherein the third party authenticates the user upon verifying that the private cryptographic key is stored in the digital wallet.

15. The system of claim 14, comprising instructions to:
receive the request from the third party independent of the wireless telecommunication network to authenticate the user based on the attribute,
wherein the attribute includes the IMEI associated with the UE,
wherein the request includes verifying whether the UE is stolen;
cause the third party to determine whether the UE is stolen by determining whether the private cryptographic key is stored in the digital wallet associated with the user;
upon determining that the private cryptographic key is not stored in the digital wallet associated with the user, cause the third party to determine that the UE is stolen; and
upon determining that the private cryptographic key is stored in the digital wallet associated with the user, cause the third party to determine that the UE belongs to the user.

16. The system of claim 14, comprising instructions to:
obtain the indication of the attribute associated with the UE operating on the wireless telecommunication network,
wherein the attribute includes an incentive to engage with the third party,
wherein the incentive includes a coupon associated with the third party;
cause the third party to determine whether the user is associated with the incentive by determining whether the private cryptographic key is stored in the digital wallet associated with the user;
upon determining that the private cryptographic key is not stored in the digital wallet associated with the user, cause the third party to determine that the user is not associated with the incentive; and
upon determining that the private cryptographic key is stored in the digital wallet associated with the user, cause the third party to determine that the user is associated with the incentive.

17. The system of claim 14, comprising instructions to:
obtain the indication of the attribute associated with the UE operating on the wireless telecommunication network,
wherein the attribute includes information associated with the wireless telecommunication network,
wherein the information indicates an action to be performed by the UE;
cause the NFT to be encrypted using the public cryptographic key associated with the user, thereby making the NFT unreadable to public users;
obtain the information contained in the NFT by decrypting the NFT using the private cryptographic key associated with the user; and
perform the action.

18. The system of claim 14, comprising instructions to:
obtain the indication of the attribute associated with the UE operating on the wireless telecommunication network,
wherein the unique ID associated with the user indicates that the user is associated with the wireless telecommunication network;
cause the third party to determine whether the user is associated with the wireless telecommunication network by determining whether the private cryptographic key is stored in the digital wallet associated with the user;
upon determining that the private cryptographic key is not stored in the digital wallet associated with the user, cause the third party to determine that the user is not associated with the wireless telecommunication network; and
upon determining that the private cryptographic key is stored in the digital wallet associated with the user, cause the third party to determine that the user is associated with the wireless telecommunication network.

19. The system of claim 14, comprising instructions to:
obtain the indication of the attribute associated with the UE operating on the wireless telecommunication network,
wherein the attribute includes an easy-to-remember phone number associated with the UE;
cause creation of the NFT including the easy-to-remember phone number;
receive a request from a second UE associated with the wireless telecommunication network to transfer the NFT including the easy-to-remember phone number; and
change a phone number associated with the second UE by transferring the NFT including the easy-to-remember phone number to a second digital wallet associated with the second UE.

20. The system of claim 14, comprising instructions to:
obtain the indication of the attribute associated with the UE operating on the wireless telecommunication network,
wherein the attribute includes an Embedded Subscriber Identity Module (eSIM) associated with the UE;
cause the third party to determine whether the UE is associated with the eSIM by determining whether the private cryptographic key is stored in the digital wallet associated with the user;
upon determining that the private cryptographic key is not stored in the digital wallet associated with the user, cause the third party to determine that the UE is not associated with the eSIM; and
upon determining that the private cryptographic key is stored in the digital wallet associated with the user, cause the third party to determine that the UE is associated with the eSIM.
